(19) United States
(12) Patent Application Publication
(10) Pub. No.: US 2014/0089818 A1
(43) Pub. Date: Mar. 27, 2014

(54) SYSTEM AND METHOD FOR CONNECTING USERS TO OTHER USERS AND OBJECTS IN A SOCIAL NETWORK

(71) Applicant: MYSPACE, LLC, Beverly Hills, CA (US)

(72) Inventor: Michael Scott Andler, Los Angeles, CA (US)

(73) Assignee: MYSPACE, LLC, Beverly Hills, CA (US)

(21) Appl. No.: 14/035,655

(22) Filed: Sep. 24, 2013

Related U.S. Application Data
(60) Provisional application No. 61/705,131, filed on Sep. 24, 2012.

(51) Int. Cl. H04L 29/06

(52) U.S. Cl. CPC H04L 65/403
USPC 715/753

(57) ABSTRACT

A method, system, and computer program product provide the ability connect/associate a first entity to a second entity on a social network. A first entity is provided with access to the social network. A representation of the second entity is displayed. In association with the second entity, a visual indication of a connectivity status between the first entity and the second entity is provided. The visual indication dynamically changes as the connectivity status changes. Further, the visual indication reflects a first one-way connection status from the first entity to the second entity, and a second one-way connection status from the second entity to the first entity.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Ser. No. 61/705,131 filed on Sep. 24, 2012, entitled “Social Media and Information Discovery Graphical User Interface” by Benjamin Johnston, Jason J. A. Knapp, Ali Tahmasbi, Joshua Couch, Fabrizio Blanco, Timothy Charles Vanderhook, Christopher J. Vanderhook, and Michael S. Andler, attorneys' docket number 257.69-US-P1;

This application is related to the following co-pending and commonly-assigned patent application(s), which is/are incorporated by reference herein:

U.S. patent application Ser. No. ______ filed on Sep. 24, 2013, entitled “Hover Card” by Michael Scott Andler, James Andrew Beaupre, Eric Juhyun Kim, Thomas Barraud Werz III, and Kyle Kincaid, attorneys' docket number 257.81-US-U1, which application claims the benefit of U.S. Provisional Patent Application Ser. No. U.S. Provisional Patent Application Ser. No. 61/705,131 filed on Sep. 24, 2012, entitled “Social Media and Information Discovery Graphical User Interface” by Benjamin Johnston, Jason J. A. Knapp, Ali Tahmasbi, Joshua Couch, Fabrizio Blanco, Timothy Charles Vanderhook, Christopher J. Vanderhook, and Michael S. Andler, attorneys' docket number 257.69-US-P1;

U.S. patent application Ser. No. ______ filed on Sep. 24, 2013, entitled “Affinity-Tag Inheritance” by Michael Scott Andler, James Andrew Beaupre, Eric Juhyun Kim, Thomas Barraud Werz III, and Kyle Kincaid, attorneys' docket number 257.82-US-U1, which application claims the benefit of U.S. Provisional Patent Application Ser. No. U.S. Provisional Patent Application Ser. No. 61/705,131 filed on Sep. 24, 2012, entitled “Social Media and Information Discovery Graphical User Interface” by Benjamin Johnston, Jason J. A. Knapp, Ali Tahmasbi, Joshua Couch, Fabrizio Blanco, Timothy Charles Vanderhook, Christopher J. Vanderhook, and Michael S. Andler, attorneys' docket number 257.69-US-P1;

U.S. patent application Ser. No. ______ filed on Sep. 24, 2013, entitled “Determining, Distinguishing, and Visualizing Users' Engagement with Resources on a Social Network” by Michael Scott Andler, Thomas Barraud Werz III, Eric Juhyun Kim, James Andrew Beaupre, and Timothy Charles Vanderhook, attorneys' docket number 257.83-US-U1, which application claims the benefit of U.S. Provisional Patent Application Ser. No. U.S. Provisional Patent Application Ser. No. 61/705,131 filed on Sep. 24, 2012, entitled “Social Media and Information Discovery Graphical User Interface” by Benjamin Johnston, Jason J. A. Knapp, Ali Tahmasbi, Joshua Couch, Fabrizio Blanco, Timothy Charles Vanderhook, Christopher J. Vanderhook, and Michael S. Andler, attorneys' docket number 257.69-US-P1;

U.S. patent application Ser. No. 13/858,857 filed on Apr. 8, 2013, entitled “System and Method for Presenting and Managing Social Media” by Michael Scott Andler, James Andrew Beaupre, Eric Juhyun Kim, and Thomas Barraud Werz III, attorneys' docket number 257.40-US-U1, which application claims the benefit of U.S. Provisional Patent Application Ser. No. U.S. Provisional Patent Application Ser. No. 61/621,057 filed on Apr. 6, 2012, entitled “System and Method for Presenting and Managing Social Media” by Mike Andler, James Andrew Beaupre, Eric Juhyun Kim, and Thomas Barraud Werz III, attorneys' docket number 257.40-US-P1;

U.S. patent application Ser. No. 13/858,720, filed on Apr. 8, 2013, by Michael Scott Andler, James A. Beaupre, Eric J. Kim, and Thomas B. Werz III, entitled “System and Method for Determining User or Resource Influence within a Pre-Defined Context”, attorneys' docket number 257.43-US-U1, which application claims the benefit of U.S. Provisional Application Ser. No. 61/621,051, filed on Apr. 6, 2012, by Mike Andler, James Andrew Beaupre, Eric Juhyun Kim, and Thomas Barraud Werz III, entitled “System and Method for Determining User or Resource Influence within a Pre-Defined Context”, attorneys' docket number 257.43-US-P1; and

U.S. patent application Ser. No. 13/858,727, filed on Apr. 8, 2013, by Michael Scott Andler, James A. Beaupre, Eric J. Kim, and Thomas B. Werz III, entitled “System and Method for Recommending Content”, attorneys' docket number 257.44-US-U1, which application claims the benefit of U.S. Provisional Application Ser. No. 61/621,049, filed on Apr. 6, 2012, by Mike Andler, James Andrew Beaupre, Eric Juhyun Kim, and Thomas Barraud Werz III, entitled “System and Method for Recommending Content”, attorneys' docket number 257.44-US-P1.

### BACKGROUND OF THE INVENTION

1. Field of the Invention

This invention relates generally to social networks, and in particular, to a method, apparatus, and article of manufacture for connecting users to other users and objects within a social network.

2. Description of the Related Art

Prior art mechanisms provide multiple mechanisms for a user to express an interest in other user and objects within a social network. For example, prior art systems provide an overcrowded social network behavior terminology around friending, following, fanning, liking, checking in, +1-ing, etc. Accordingly, users and interested parties must learn both the meaning of such terms as well as how to use such features in one or more social networks. Further, within a social network, users must use different mechanisms to indicate/express an interest in different entities. Accordingly, it is desirable to have a simple, clean and elegant user interface that allows users to express their interest in and visualize their affinity to other users/objects throughout a social network. To better understand the problems of the prior art, a description of prior art social networking behavior terminology and uses may be useful.

As described above, prior art social networks utilize a variety of different terminology to reflect different mechanisms for expressing an interest in and visualizing a user's affinity to other users/objects. As an example, a “friend” within the Facebook™ social network is someone that a user may connect and share with within the social network. In other words, to express an interest in another user within the Facebook™ social network, a user may be required to search for and add that user as a “friend”. The added user must then “accept” that user as a friend to establish the “friend” relationship. Once friended, depending on the privacy/security settings established by the users, friends may have access to another friend's activity stream/updates, pictures, personal information, etc.

In contrast to “friending,” to express an interest or to provide positive feedback and connect with things a user cares about, the user may “like” a web page, another user's post, etc. For example, if a user desires to indicate an interest in a concert venue, the user must search for and find a social network page corresponding to that venue and “like” that page. Once the user “likes” the page, the user may have access to/view that page's activity stream.

Another term used in the prior art is “follow” which provides a mechanism for a user to see public updates from the people a user is interested in. A user “follows” another user and will receive updates from the followed user in his/her own user's “news feed.” However, confusingly, if a user is interested in keeping up with a Page (e.g., businesses, organizations, bands, etc.), the user utilizes may be required to “like” the page.

“Fanning” is utilized in a similar manner to “liking” a page and refers to a user become a “fan” of their favorite page.

“Checking-in” refers to the concept where a user may “check-in” (e.g., using their mobile device/phone) at different places a user visits (e.g., bars, markets, concert venues, etc.). In other words, the user identifies a location that the user has visited using a “check-in” feature of a social network (e.g., on the Foursquare™ social network).

“+1-ing” refers to a method within the Google+™ social network for how a user shows their appreciation for a post/object. For example, a user may “+1” a post within the Google+™ social network by clicking a “+1” link/icon. Thereafter, the creator of the post and the people the post was shared with can see the user's “+1”. Users can also “+1” something on a website which adds to the total number of “+1”s shown in a count for that item.

In view of the above, one may note that a variety of methods are used across different social networks to indicate/express an interest in and to visualize their affinity to other users/objects within a social network. The number of different methods used can be confusing and repetitive and fails to provide a simple and easy to use and understand method/display for expressing an interest and visualizing a user's affinity.

### SUMMARY OF THE INVENTION

Embodiments of the invention provide an integrated icon displaying connectivity status and affinity between users/objects. Further, a “connect” feature provides a single data “binding” activity throughout a social network.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the general structure and interaction within an social media network framework/system in accordance with one or more embodiments of the invention;

FIG. 4 illustrates exemplary symbols utilized to represent connections in accordance with one or more embodiments of the invention;

FIG. 5 illustrates alternative graphical user interface symbols used to represent connections in accordance with one or more embodiments of the invention;

FIG. 6 illustrates an exemplary graphical user interface where internal circles of varying size, color, shade represent different connections/affinity in accordance with one or more embodiments of the invention;

FIG. 7 illustrates an exemplary context sensitive hover operation dialog box that may be displayed in accordance with one or more embodiments of the invention; and

FIG. 8 illustrates the logical flow for connecting a first entity to a second entity on a social network in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention. Embodiments of the invention include systems and methods for presenting and managing connections between users/objects on a social network.

### Hardware Environment

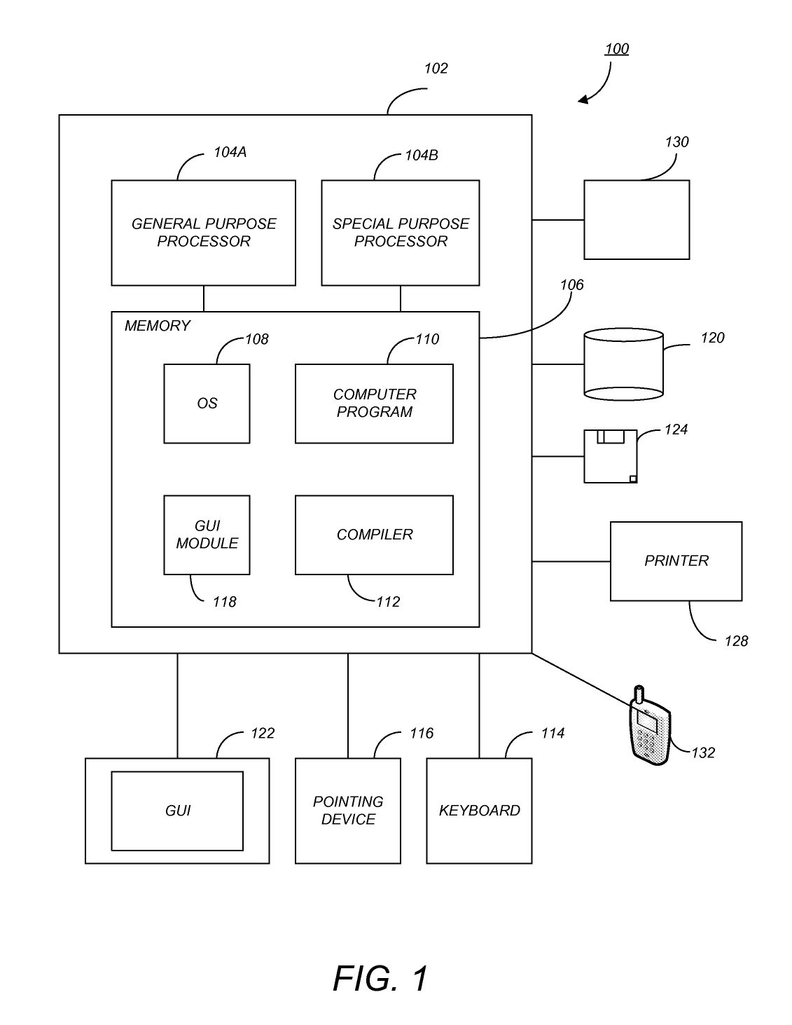

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor 104B is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory 106, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

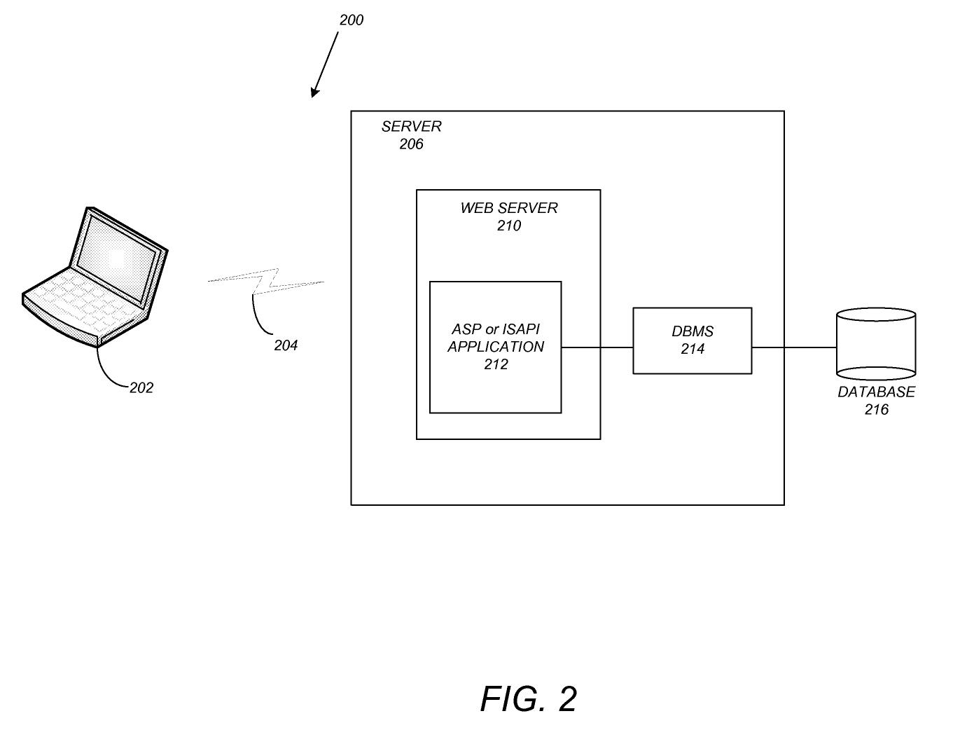

FIG. 2 schematically illustrates a typical distributed computer system 200 using a network 204 to connect client computers 202 to server computers 206. A typical combination of resources may include a network 204 comprising the Internet, LANs (local area networks), WANs (wide area networks), SNA (systems network architecture) networks, or the like, clients 202 that are personal computers or workstations (as set forth in FIG. 1), and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 202 and servers 206 in accordance with embodiments of the invention.

A network 204 such as the Internet connects clients 202 to server computers 206. Network 204 may utilize ethernet, coaxial cable, wireless communications, radio frequency (RF), etc. to connect and provide the communication between clients 202 and servers 206. Clients 202 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 202 may be downloaded from server computer 206 to client computers 202 and installed as a plug-in or ACTIVEX™ control of a web browser. Accordingly, clients 202 may utilize ACTIVEX™ components/component object model (COM) or distributed COM (DCOM) components to provide a user interface on a display of client 202. The web server 210 is typically a program such as MICROSOFT′S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 202 instead of communicating/obtaining the information from database 216 across network 204. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 202 and 206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 202 and 206.

### Software Embodiment Overview

Embodiments of the invention are implemented as a software application on a client 202 or server computer 206. Further, as described above, the client 202 or server computer 206 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems. Users may communicate and interact with the software application using a mobile device, client computer 202, portable device, etc.

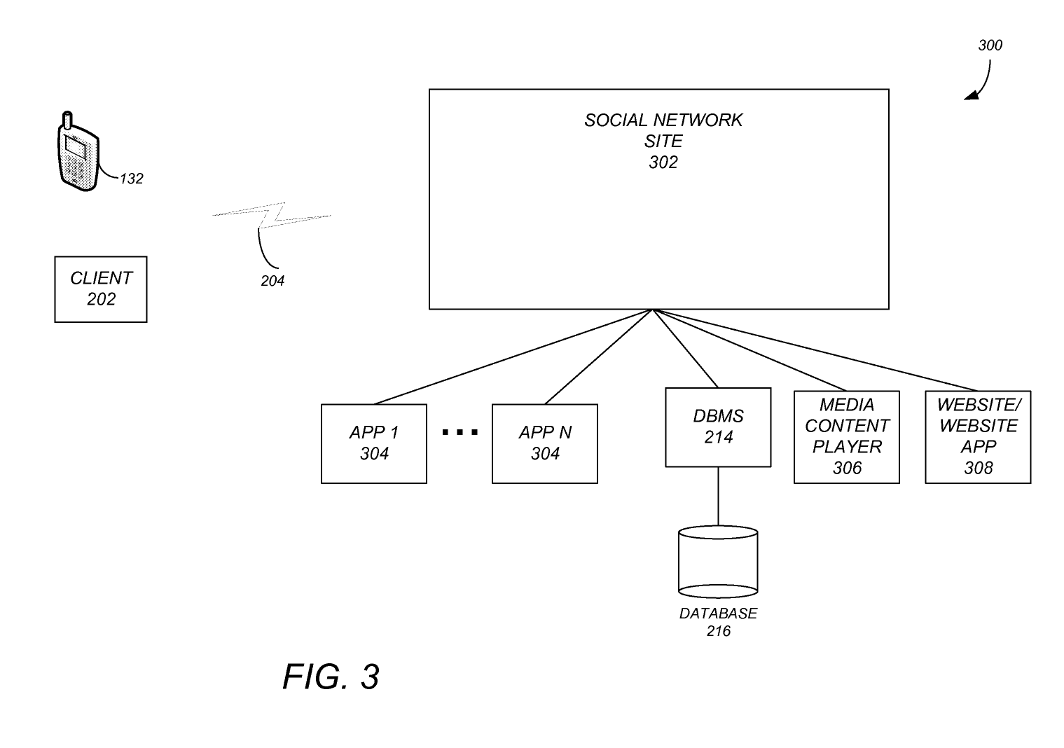

FIG. 3 illustrates the general structure and interaction within an social media network framework/system in accordance with one or more embodiments of the invention. As described above, mobile device 132 and/or client 202 (also referred to herein as user 202) may communicate and interact using a variety of networks 204 with various websites and applications. Mobile application software (commonly referred to as an “app”) may be installed and/or utilized on mobile devices 132 and/or clients 202. Such an app may be downloaded from an application marketplace or online store of applications. The app may be used to provide the functionality herein.

In addition, various apps may be used in combination with server side applications to provide the desired functionality. For example, a user 202/132 may install an app on his/her smart phone or tablet device (e.g., iPad™) that is configured to communicate with a social network site 302 and display relevant information on the user's device. Information displayed via the app on the user's device may be pushed to the user's device or pulled from the site 302 depending on the configuration of the app.

On the server side 206, a social network site 302 (e.g., Myspace™ Facebook™, LinkedIn™, Friendster™, Twitter™, Foursquare™, Pinterest™, Instagram™, etc.), may provide an interactive experience to a variety of users 202/132 that access such a social network site 302. Users 202/132 may access social network site 302 via a web browser or via an app on the user's device.

Users 202/132 accessing a social network site 302 may be members of site 302 or may access information without being members. In this regard, access to a site 302 or certain areas of site 302 may be limited to users 202/132 that are members and are logged in to such a site 302. Such a logon may be automatic (e.g., preconfigured using cookies on a web browser or by storing a username/password on the user's device or in the app on the user's device).

Either as part of the social network site 302 or executing separately from the social network site 302, various applications 304-308 may be used to provide additional features to the social network site 302. It may be noted that the description is not limited to the applications depicted in FIG. 3 and additional applications may be used to provide the features described herein. Further, such applications 304-308 may be directly integrated with (e.g., are an integral part of) social network site 302, may interact with each other, and or may interact directly with the user 202/132.

Apps 304 may provide a variety of functionality ranging from games, to facial recognition, to media content discovery, etc. For example, one app 304 may consist of a recommendation engine that is configured to recommend content, events, etc. to a user 202/132 (e.g., based on content gathered and/or stored by social network site 302). DBMS 214 manages all of the data that may be stored in database 216. Media content player 314 enables the ability to view media content uploaded by users 202/132 (or uploaded by a host of site 302). Websites/website apps 308 are websites other than the social network site 302 (e.g., Twitter™, search engines, map-based interactions, etc.) that may use information from social network site 302 or provide additional information based on the social network information.

The platform and processing capabilities that provide an integrated graphical user interface that displays connectivity status and affinity between users/objects and may be performed by client 202, server 206, and/or a combination of client 202 and/or server 206 within a social network.

As used herein, a “social network” (or social network site) refers to a platform or service (e.g., website, web service, application, etc.) that enables users to build social relations based on shared interests, activities, backgrounds, and/or real-life connections. A social network provides a representation of each user (e.g., a profile), his/her social links, and a variety of additional services. As described above, many social networks/sites 302 are web-based and provide means for users to interact over a network 204 (e.g., the Internet, e-mail, and instant messaging). Social networking sites 302 allow users to share ideas, pictures, posts, activities, events, and interests with people in their network. Further, social networking sites 302 provide an electronic/computer-implemented means/representation of a social structure made up of a set of social actors (e.g., individuals or organizations) and a set of connections between such actors. In addition to providing the ability for users to connect to one-another, a social network 302 may also enable users to connect with groups (e.g., music groups), objects, locations, etc. However, embodiments of the invention are not intended to be limited to the social networks 302 described above but intend to cover any type of social network 302 where users can connect/communicate with one another and objects via electronic means.

Embodiments of the invention provide a simple, clean and elegant user interface that allows users/clients 202/132 to express their interest in and to visualize their affinity to other users/objects throughout a social network site 302. Further, embodiments of the invention simplify today's overcrowded social networking behavior terminology around friending, following, fanning, liking, checking in, +1-ing, etc. Embodiments also build a unified data platform throughout an entire social network content ecosystem 300, enabling highly accurate and relevant recommendations, suggested content, affinity matching and targeted ad serving opportunities. Further, embodiments of the invention provide an integrated icon displaying connectivity status and affinity between users/objects. Such an icon additionally may indicate online/offline status (e.g., for messaging).

### Connect Graphical User Interface

Embodiments of the invention provide the ability for a user to connect to any piece of content or any user 202/132. In this regard, after logging in, a user 202/13 (e.g., a registered user/member) of a social network 302 may have the ability to connect to any of the following—people, artists, songs, videos, photos, albums, mixes (photos, music, etc.), etc. Connections are one-sided relationships—meaning that if a first user connects to a second user, the second user doesn't have to approve or connect back to the first user if they choose not to (except if the user is private, in which case they may have to approve a connection request). In this regard, privacy settings (of a logged-in user) may determine whether users can/cannot connect to a logged-in user. Such privacy settings may depend on whether a logged-in user's profile is public or private. If a logged-in user has a public profile, any user can connect to the logged-in user the logged-in user will receive a notification each time a user connects to the logged-in user. If a profile is private, the logged-in user will receive a notification each time a user initiates a connection with the logged-in user and the logged-in user will be prompted to approve or deny each request.

Accordingly, notwithstanding the specific case of a private user, once a first user has decided to connect to a second user, even that one-way connection allows the first user to see and comment on the second user's activities. If the second user chooses to connect back to the first user, then the mutual connection will allow the second user to see and comment on the first user's activities as well.

In view of the above, establishing a connection with other users, or artists, allows a logged-in user to view the other user's/artists latest activity. It may also expand a logged-in user's social graph and enable the logged-in user to explore shared connections, both people and content. Similarly, connecting to an object/piece of content (e.g., song, photograph, video, album, or mix), adds the object/content to the logged-in user's personal library for easy access and also places the object/content in the logged-in user's stream, making it visible to all of the logged-in user's connections, or the public, depending on the logged-in user's privacy settings. Connecting to content also improves a social network's ability to make recommendations for additional content the logged-in user may enjoy.

Such a connection feature simplifies the concept of “following”, “friending”, “liking”, or “adding” a user or piece of content—unifying a user's association with any object (users, photos, mixes, albums, songs, videos, etc.) on the social network site. Further, such a connection configuration provides a more accurate representation of relationships on the site (e.g., a user may follow an artist, but that artist doesn't need to follow the user back for the user to see their activity). Connecting to users and content helps a social network website collect more information on the user's interests (which may be used in the calculation of an “affinity” as described in related applications and also helps a social network site deliver better recommendations to users/members).

In view of the above, while the “connect” feature provides the ability for a user to “connect” to other users/objects, a “connections” feature organizes everyone (e.g., friends, artists) and everything (e.g., songs, images, albums) to which a user is connected. Connections may be accessed using a button within a social network website/application (e.g., within a contextual navigation menu) and can be filtered by type (e.g., the type of connection such as people [user-user], songs [user-song], albums [user-album], videos [user-video], photos [user-photo], etc.) (e.g., using a drop down menu or other selection technique). In addition, a “Top 8” feature allows a social network user to select up to eight (8) personal connections to be highlighted by displaying them directly on the user's profile (e.g., within a social network). Such a top 8 is determined by the user (unlike a Top Fans feature, which may be computed based on the level of interaction the user has with another user/group/object/etc.). In addition, a logged-in user may view all content/people to which the user has connected by visiting a library section found within a logged-in user's homepage. Such content/people in the library may be segmented by type.

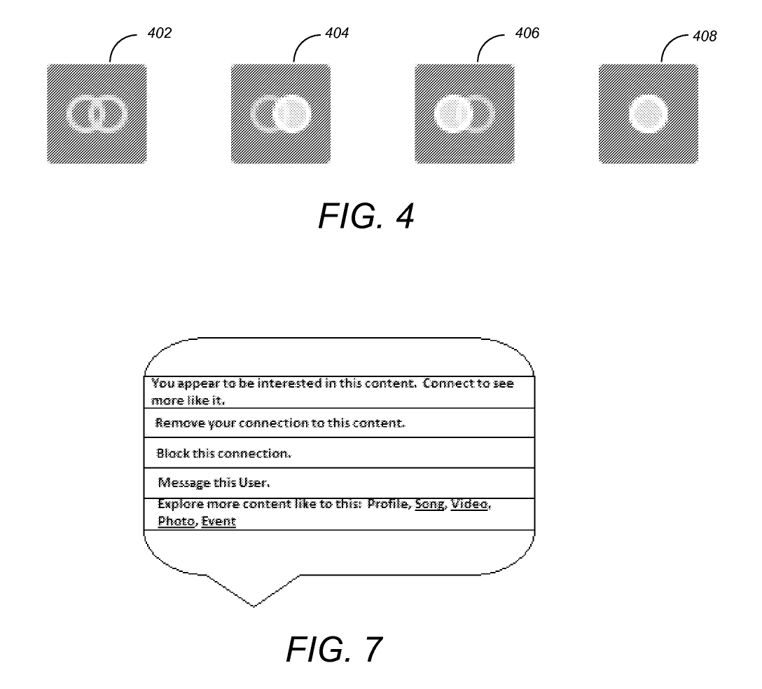

FIG. 4 illustrates exemplary symbols utilized to represent connections in accordance with one or more embodiments of the invention. Overlapping circles represent connections—much like a Venn diagram. The circles can be clicked like buttons to create, reciprocate or remove a connection. Thus, a user can simply click on one of the connection symbols 402-408 and the shading of the circles may change to indicate the change in the connection. In this regard, a change in the status of a connection will cause the symbol to change its appearance/state as described below. The transition from one state to another state may be animated (e.g. performed via an animation). Symbol 402 indicates that no connection exists between a logged-in user (e.g., you) and the object/user. Symbol 404 indicates that a user/object has connected to the logged-in user (e.g. you), but the logged-in user has not connected to the user/object. Symbol 406 indicates that the logged-in user has connected to a user/object, but the user/object has not connected to the logged-in user. Symbol 408 indicates a two-way connection (i.e., both the logged-in user and the user/object have connected to each other). In one or more embodiments when a user connects with a particular object, the reverse connection (i.e., from the object back to the user) is automatically performed resulting in the display of symbol 408. For example, if a user connects to/creates a song mix, there will automatically be a two-way relationship that results.

As an alternative to the symbols 402-408 of FIG. 4, other graphical user interface elements may reflect the connection status of the invention. For example, a chain with links of a chain closing (indicating a connection) and/or different arrangements of broken and closed links may be utilized.

When a user holds a mouse cursor over a connect symbol 402-408, information/options that are context sensitive to that particular connection may be displayed. The information/options may be displayed in a variety of manners. For example, the information/options may be displayed via a drop-down menu with several options to engage with the connected object/person outside of connecting. For example, if the user hovers over a song, the options may display options that are relevant to songs including the connection status, an option to add the song to a playlist, to play the song, to create a radio mix with that song, share the song (e.g., on the user's stream or with a particular set of users), report a song (if its improperly tagged or has the wrong information), make the song the user's profile song, etc. Similarly, if a user hovers over a connect icon associated with another user, options may include “connect” and “share” (which may share the user's profile over the current user's stream) (e.g., with the option to make a comment such as “cool user profile”).

In one or more embodiments, the concept of sharing (both internally and external broadcast to other sites/services) may be incorporated within the set of dialogs and behaviors of the connect feature/control. For example, upon connection to a resource, the dialog may prompt the user whether he/she'd like this connection to be broadcasted to Facebook™/Youtube™, etc. (depending on that user's connect/privacy settings). In this regard, broadcasting a connection is synonymous with sharing, and will facilitate the viral spread of content in precisely the same manner. Additionally, “thumbs up” and “thumbs down” activities may also be incorporated into the connect feature/control. For example, upon mouse-over of the universal connect icon/symbol, a dialog may prompt the user with questions such as “Connect to more content like this?” or “Connect to less content like this?”. The response to this set of carefully worded questions may provide similar utility as “thumbs up” and “thumbs down” controls.

An alternative graphical user interface to that of FIG. 4 is illustrated in FIG. 5. Different colors/patterns may be used to represent whether a user is connected to a user, is online/away, and/or is available. A description of each of the symbols and their representations follow.

Symbol 502 indicates that object A has connected to object B, 22 others have connected to object B, object A is online and available, object B is not connected to object A, no affinity data is available, and 28 others have commented on object B. As an example, the color green or a particular shading pattern (e.g., the left side of symbol 502) may represent that a user/object has connected to another user/object and is online and available.

Symbol 504 indicates that object A is not connected to object B, object B is connected to object A, object B is online and available, and no affinity data is available.

Symbol 506 indicates that object A is connected to object B, object A is online and available, object B is connected to object A, object B is online and available, objects A and B are “friends” and can message one another, and no affinity data is available.

Symbol 508 indicates that object A is connected to object B, object A is online and available, object B is connected to object A, object B is online and away (e.g., indicated by yellow shading or a different shading pattern on the left side of symbol 508), and no affinity data is available.

Symbol 510 indicates that object A is connected to object B, object A is online and available, object B is connected to object A, object B is not online, and affinity between A and B is high/broadly shared (e.g., A and B have similar affinity for similar objects). The affinity shared may be indicated by the length/number of the line vectors displayed a star-like pattern in the center of symbol 510. In an exemplary embodiment, the number of line vectors may reflect whether affinity is narrow, wide, or broadly shared. In addition, the length of the arrows may reflect whether affinity is medium or high. An example of broad ranging affinity would be two entities that share similar characteristics in a variety of categories such as music genres, gender preference, age range/preference, activity types (song plays, concert attendance, etc). Hence, line density represents the number of categories of affinity overlap whereas line length represents the average affinity overlap strength. Symbol 520 therefore represents strong affinity across a narrow range of categories. Symbol 522 represents weak affinity across a wide range of categories.

Symbol 512 indicates that object A is blocking object B (e.g., indicated by red shading or a different pattern of shading on the left side of symbol 512), object A is not available, object B is connected to object A, object B is online and available, and there is medium/narrow shared affinity between A and B (e.g., indicated by medium length line vectors in the star-like pattern in the center of symbol 512).

Symbol 514 indicates that object A is connected to object B, object A is not online, and object B is not permitted to bi-directionally connect.

Symbol 516 indicates that object A is connected to object B, object B is not permitted to bi-directionally connect, and there is a medium/broad shared affinity between A and B.

Symbol 518 indicates that object A is not connected to object B, object A is not online, object B is not connected to object A, object B is not online, and no affinity data is available.

Symbol 520 indicates that object A is not connected to object B, object A is not online, object B is not connected to object A, object B is not online, and there is a high/narrow shared affinity between A and B.

Symbol 522 indicates that object A is not connected to object B, object A is not online, object B is not connected to object A, object B is not online, and there is a medium/broad shared affinity between A and B.

Symbol 524 indicates that object A is not connected to object B, object A is not online, object B is not connected to object A, object B is not online, and A and B have medium/wide share affinity.

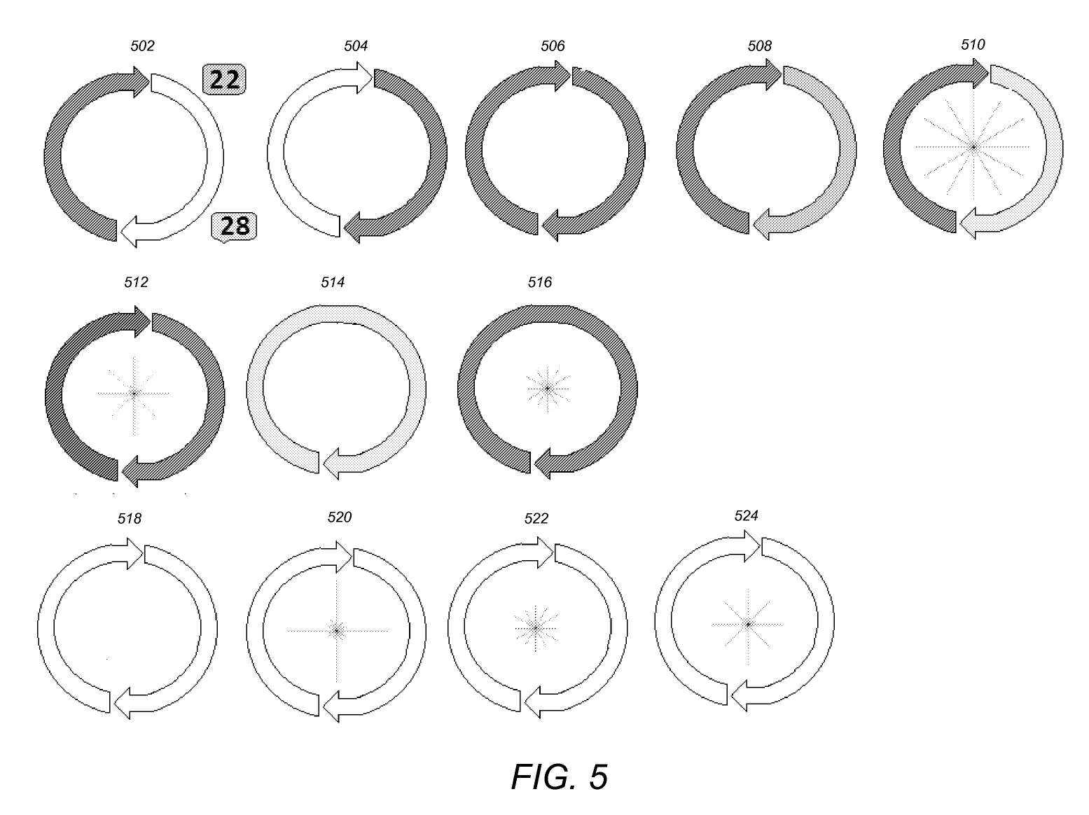

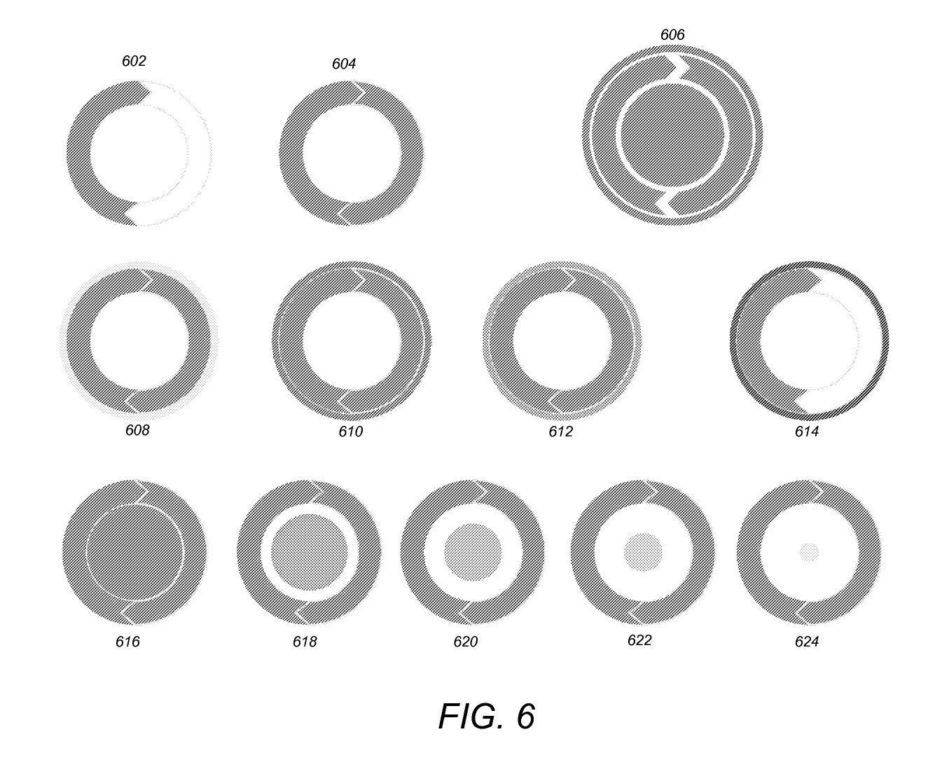

In addition, the radial line affinity treatment illustrated in FIG. 5 may not be utilized. As an alternative, internal circles of varying size, color, shade may be utilized. An exemplary graphical user interface where internal circles of varying size, color, shade represent different connections/affinity is illustrated in FIG. 6.

The clockwise directional arrows of symbols 502-524 and 602-624 provide simplicity and the fact that the resulting circle implies connectivity, yet the combination of the two sides enables a visualization of bi and uni directional connections. Shaded arrows indicate connectivity between a source and target users/resource has been established. The color/pattern coding rules of the outer rings may be consistent with other applications (e.g., instant messaging): green indicates available; orange indicates away; gray indicates not online; and red indicates blocked.

When viewing the symbols 502-524 and 602-624, the frame of reference may always be Viewer→Viewed. In other words, if the left side of the icon is shaded, it means the viewer is connected to the item/user being viewed. If the right side is shaded, it means the object/user being viewed is connected to the viewer.

Referring now to FIG. 6, symbol 602 indicates object A has connected to object B, and object B has not connected to object A, and there is no affinity information available (indicated by the lack of an interior circle). Symbol 604 indicates that both objects A and B have connected to each other and no affinity information is available. Symbol 606 indicates that both objects A and B have connected to each other, both objects are available and online (green outer ring), and there is a high/broad shared affinity (indicated by the large darkly shaded interior circle). Symbol 608 indicates objects A and B have connected to each other but are not currently online (e.g., indicated by the gray outer ring), and no affinity information is available. Symbol 610 indicates that objects A and B have connected to each other, both objects are available and online, and no affinity information is available. Symbol 612 indicates that objects A and B have connected to each other, one of the two objects is away (indicated by the orange outer ring), and no affinity information is available. Symbol 614 indicates object A has connected to object B, object B has not connected to object A, object B is blocked from connecting to object A (indicated by the red outer ring), and no affinity information is available. Symbols 616-624 all indicate both objects A and B have connected to each, and there is a decreasing amount of affinity between objects A and B as one progresses from icon 616 to icon 624 (indicated by smaller and lighter interior shaded circles).

In addition, if the user hovers over a particular symbol (402-408, 502-524, 602-624), a menu may appear within a dialog box such as that illustrated in FIG. 7. Such a menu may provide user-selectable options including:
You appear interested in this content. Connect to see more like it.
Remove your connection to this content.
Block this connection.
Message this User.
Explore more content like this: Profile, Song, Video, Photo, Event.

Such menu options may be selectable by selecting the entire option/sentence or by selecting individual hyperlinks (e.g., Profile, Song, Video, Photo, Event).

Thus, the user interface behavior provides that mousing over the icons will pull menus that present appropriate choices based on the current state. For example, if a logged-in user is connected to another user/profile, the logged-in user can mouse over the connect symbol 402-408/502-524/602-624 and be presented with multiple options such as: View this User, Message This User, Disconnect from this Content, Block, Explore Similar, etc.

### Connect Feature Functionality Overview and Benefits

Embodiments of the invention provide for the “connect” feature to be utilized as the single data “binding” activity throughout all of a social network, both with a unified user interface and also a shared data infrastructure. Examples of data binding include what has historically been referred to as following, friending, +1'ing, liking, subscribing, fanning, etc. Examples of the data types that will be “bound” by the connect feature include:
1. person→person connection (uni/bi-directionally, as in following, friending);
2. person→media object connection (e.g.,—liking a photo, video);
3. person→event connection (e.g.,—fan of an artist who attended or is attending a concert);
4. profile→event connection (e.g.,—Coke™ profile promoting U2 concert); and
5. profile→profile connection (e.g.,—Sony™ profile's endorsement of the Playstation3™ profile).

Within the underlying data platform, all of these objects/entities are treated the same, and may include varying degrees of metadata, indicating their type and other globally relevant information. The connections between the objects/entities are either uni or bi-directional, depending on type. For example, a user can connect to a video but a video likely wouldn't connect back to a user. In contrast, a user could connect to an event and the event (by way of an event administrator) could connect back to a user. This would enable private messaging to concert goers, etc. Global site functionality rules and security will be dependent on the directionality of connections (e.g., bidirectional vs. unidirectional messaging restrictions, similar to Twitter™'s messaging rules).

Examples of possible use cases include:
Mike is connected with Jane;
Amy and Jennifer are connected;
Steve just connected with Aerosmith;
Johnny is connected with Death Cab for Cutie and 5 other artists;
Pepsi and the 2016 Summer Olympics are connected;
Tom connects with Freakonomics;
Michelle connected with Josh and 10 others at U2 at Staples Center;
Connect with more Rock Music using the new Trending Charts;
Connect with Justin Timberlake and Kenna in their new video “XYZ”.
etc.

There are various underlying benefits for utilizing the connect feature as described herein. More specifically, the Internet's social networking and media space has become overly crowded by noise, due to the vast number of activities individuals perform demonstrating their affinity to content and other users. Liking, subscribing, fanning or following a piece of content or an artist/person are all activities that ultimately accomplish the same thing—they allow the “actor” to indicate he/she identifies with the object.

The connect feature of embodiments of the invention greatly simplifies this interaction. Anything within a social network's content ecosystem can be connected to anything else. A single, simple graphical control/indicator icon (e.g., as illustrated in FIG. 3) both enables connectivity to be requested while also serving as an indicator of the status, directionality and strength of connections. Strength and directionality of connections in turn drive deeper data integration within systems that provide highly accurate recommendations, suggested affinities toward tagged subject matter as well as highly targetable, relevant ad serving data.

### Connect Feature Complex Use Cases

In addition to a providing a simple, innovative and unified graphical user interface solution, the underlying linked data of the connect feature facilitates the development of a broad range of consumer facing solutions. Users' affinity scores to all content, artists and events on a social network may be continuously incremented (or decremented) based on their interaction with the site. Users who simply play songs or view photos will cause their affinity to the “tags” in those photos to increase. This is an example of what is referred to as an “implicit connection.” Tags are not limited to people's names pictured in the photo, but to a generic set of normalized data. For photos, this may be venue data derived from mobile latitude/longitude coordinates. A photo then could be automatically “tagged” with U2™, Staples Center™, music, concert, etc. These tags would then be “inherited” by users who view the photo, thereby increasing their affinity to content like it.

After reaching a threshold of “implicit affinity” toward a particular tag or set of tags, the connect feature/system may prompt the user with a message such as “It looks like you are interested in U2™, concerts and the Staples Center™. Click OK to explore more content like this.” This essentially then becomes an explicit content/ad targeting opportunity. If the user clicks ignore, they simply remain implicitly connected to the content. If they click “No, I'm not interested” then the user's affinity may be decremented or zeroed-out with that content. Every single interaction that a user performs on a social network site can contribute to his/her implicit affinity.

In addition to the above, to explore/discover content, each piece of consumed content (e.g., content/users that a logged-in user has “connected” with) may open an exploration window(s) to other similar content items.

Further, to ensure that content discovery and consumption is accurate and useful, existing data may be seeded with highly relevant metadata (e.g., into an underlying data infrastructure such as database 124 of FIG. 1 or database 216 of FIGS. 2 and 3). In this regard, metadata regarding content may be stored in databases 124/216 and accessed by a social network site 302. Such metadata may include things like song names, descriptions and artist bios, accurate music genres, associated song moods, etc. Once a working set of seeded data is acquired/established, the usage patterns of consumers/users (of a social network site) result in an inheritance based crowd sourcing of tags. Further, such seeded metadata may provide the foundation for evolving the connect feature into a highly sophisticated content/ad targeting and recommendation systems.

### Logical Flow

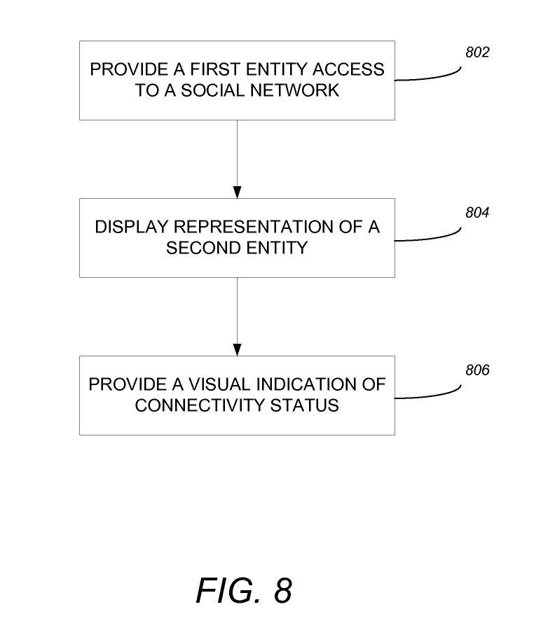

FIG. 8 illustrates the logical flow for connecting a first entity to a second entity on a social network in accordance with one or more embodiments of the invention.

At step 802, a first entity (e.g., a logged-in user) is provided with access to a social network.

At step 804, a representation of a second entity is displayed. Such a representation may be an icon, a button, a picture, a video, etc. In this regard, an administrator may designate a particular representation for the object (e.g., the picture of a music artist/actor, graphic art, a video, etc.). Further, the second entity may be a second user, and/or an object other than a user (e.g., business, artist [i.e., a public persona of a musical artist/actor and not their personal page/representation), song, videos, photos, albums, mixes, profile, event, etc.)

At step 806, in association with the second entity, a visual indication of a connectivity status between the first and second entities is provided (e.g., displayed or overlaid [transparently/semi-transparently] on top of the second entity). The visual indication dynamically changes as the connectivity status changes. Further, the visual indication reflects a first one-way connection status from the first entity to the second entity and a second one way connection status from the second entity to the first entity.

The visual indication may take a variety of forms and the invention is not intended to be limited to any one graphical user interface/representation. An exemplary representation provides for two overlapping circles (e.g., a Venn-like diagram) with shading that indicates the connectivity status. In this regard, the shading of a first circle of the two overlapping circles may reflect the first one-way connection status (e.g., form the first entity to the second entity), while shading of a second circle may reflect the second one-way connection status (e.g., from the second entity to the first entity). The first circle and second circle may entirely coincide when both one-way connection statuses indicate connections have been established in both directions (e.g., simultaneously).

Step 806 may also include the selection of one or more parts of the visual indication (e.g., a user clicking on or selecting one of the circles in a Venn-like representation). The selection of such a part serves to modify the connectivity status based on the selection. Further, the visual indication dynamically changes based on the modified connectivity status. Such a dynamic change may provide an animation for the transition from one status to another of the visual indication. Further, the change in the visual indication may shade/unshade/merge the different components/parts of the visual indication (e.g., merging two circles into a single circular representation).

The visual indication may also reflect a directionality and strength of the connectivity status between the two entities. Further, embodiments of the invention may also enable context sensitive operations. In such an embodiments, a hover operation (e.g., using a cursor via a mouse or a finger on a tablet device) over the visual indication may be accepted. In response to the hover operation, information or options (that are context sensitive to the connectivity status between the two entities) may be displayed (e.g., a menu with context sensitive selectable operations).

In addition, to enable the connect visual indication, metadata relating to the connectivity status between the two entities may be stored (e.g., in a database). The visual indication is then based on such stored metadata. Further, the metadata may be updated dynamically as users/entities change within the social network.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for connecting a first entity to a second entity on a social network comprising:
providing the first entity access to the social network;
displaying a representation of the second entity;
providing, in association with the second entity, a visual indication of a connectivity status between the first entity and the second entity, wherein:
the visual indication dynamically changes as the connectivity status changes; and
the visual indication reflects a first one-way connection status from the first entity to the second entity, and a second one-way connection status from the second entity to the first entity.

2. The computer-implemented method of claim 1, wherein the first entity comprises a first user that is logged-in to the social network.

3. The computer-implemented method of claim 2, wherein the second entity comprises a second user.

4. The computer-implemented method of claim 2, wherein the second entity comprises an object other than a user.

5. The computer-implemented method of claim 1, further comprising:
selecting one or more parts of the visual indication;
modifying the connectivity status based on the selecting; and
dynamically changing the visual indication that is provided based on the modified connectivity status.

6. The computer-implemented method of claim 1, wherein the visual indication comprises two overlapping circles with shading that indicates the connectivity status.

7. The computer-implemented method of claim 1, wherein the visual indication reflects a directionality and strength of the connectivity status between the first entity and the second entity.

8. The computer-implemented method of claim 1, further comprising:
accepting a hover operation over the visual indication; and
displaying information or options that are context sensitive to the connectivity status between the first entity and the second entity.

9. The computer-implemented method of claim 1, further comprising:
storing metadata relating to the connectivity status between the first entity and the second entity; and
providing the visual indication based on the stored metadata.

10. A system for connecting a first entity to a second entity on a social network comprising:
(a) a server computer;
(b) a social network application executing on the computer; wherein the social network application is configured to:
(1) provide the first entity access to the social network application;
(2) display a representation of the second entity;
(3) provide, in association with the second entity, a visual indication of a connectivity status between the first entity and the second entity, wherein:
(i) the visual indication dynamically changes as the connectivity status changes; and
(ii) the visual indication reflects a first one-way connection status from the first entity to the second entity, and a second one-way connection status from the second entity to the first entity.

11. The system of claim 10, wherein the first entity comprises a first user that is logged-in to the social network.

12. The system of claim 11, wherein the second entity comprises a second user.

13. The system of claim 11, wherein the second entity comprises an object other than a user.

14. The system of claim 10, wherein the social network application is further configured to:
select one or more parts of the visual indication;
modify the connectivity status based on the selecting; and
dynamically change the visual indication that is provided based on the modified connectivity status.

15. The system of claim 10, wherein the visual indication comprises two overlapping circles with shading that indicates the connectivity status.

16. The system of claim 10, wherein the visual indication reflects a directionality and strength of the connectivity status between the first entity and the second entity.

17. The system of claim 10, wherein the social network application is further configured to:
accept a hover operation over the visual indication; and
display information or options that are context sensitive to the connectivity status between the first entity and the second entity.

18. The system of claim 10, wherein the social network application is further configured to:
store metadata relating to the connectivity status between the first entity and the second entity; and
provide the visual indication based on the stored metadata.
